(19) United States
(12) Patent Application Publication
(10) Pub. No.: US 2026/0250977 A1
(43) Pub. Date: Aug. 27, 2026

(54) TEMPORARY FENCING AND GATE ASSEMBLY

(71) Applicant: VORP Energy International LLC, Rexburg, ID (US)

(72) Inventors: Justin Gant, Lynnwood, WA (US); Michael Stilwell, Lynnwood, WA (US)

(21) Appl. No.: 19/545,699

(22) Filed: Feb. 20, 2026

Related U.S. Application Data
(60) Provisional application No. 63/761,469, filed on Feb. 21, 2025.
(60) Provisional application No. 63/761,476, filed on Feb. 21, 2025.

(51) Int. Cl. E04H 12/22; E04H 17/18

(52) U.S. Cl. CPC E04H 12/2246; E04H 17/18

(57) ABSTRACT

A ballast assembly for a temporary barrier system may include a container body defining a ballast receptacle for receiving and retaining ballast, a first post-receiving receptacle member secured to the container body and configured to removably receive a temporary barrier post in one of a plurality of positions relative to vertical, and a post mounting assembly configured to facilitate coupling of a temporary barrier post to the container body in each of the plurality of positions relative to vertical. A temporary barrier system may include one or more ballast assemblies, one or more temporary barrier posts configured to couple to the one or more ballast assemblies, one or more temporary barrier panel configured to couple to the one or more temporary barrier posts, and one or more clips configured to couple the one or more temporary barrier panel to the one or more temporary barrier posts.

### CROSS REFERENCE TO RELATED APPLICATIONS

This application claims priority to Provisional Application No. 63/761,469 filed Feb. 21, 2025, and Provisional Application No. 63/761,476 filed Feb. 21, 2025, the entire disclosures of which are hereby incorporated by reference.

### BACKGROUND

With changes in technology and consumer demand, increasing numbers of locations require access restrictions to maintain a secure environment. These locations can vary widely, including industrial facilities, manufacturing spaces, distribution centers for processing shipping and logistics, and event spaces for a high-profile media event. While in the past, the relative centralization of facilities requiring increased security meant that security logistics planners could rely on permanent security installations to control access to the activity locale, today these types of activities are more likely to pop up quickly and require rapid deployment of security operations, such as a barrier system. A permanent security perimeter barrier system requires extensive anchoring to the ground, and this type of anchoring will typically require extensive permitting before it can be put in place, a regulatory process that can take six to twelve months or longer depending on the local rules.

Thus, traditionally, security personnel planning for a temporary or pop-up location requiring additional security will use quick temporary installation barriers, such as temporary chain link fencing. Temporary barrier systems typically include modular barrier panels and ballast support means, such as weighted support bars or platforms. The ballast systems can either be relatively lightweight and easy to position or install or can be extremely heavy and difficult to position and move. Temporary barrier systems that use relatively lightweight ballasts are suitable for erecting the temporary barrier system; however, they are often unstable against extreme weather conditions or against toppling by an intruder.

The present disclosure relates to improved rapidly deployable temporary barrier systems.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

In some aspects, the techniques described herein relate to a ballast assembly for a temporary barrier system, including: a container body defining a ballast receptacle for receiving and retaining ballast; a first post-receiving receptacle member secured to the container body and configured to removably receive a temporary barrier post in one of a plurality of positions relative to vertical; and a post mounting assembly configured to facilitate coupling of the temporary barrier post to the container body in each of the plurality of positions relative to vertical.

In some aspects, the techniques described herein relate to a temporary barrier system including: one or more ballast assemblies; one or more temporary barrier posts configured to couple to the one or more ballast assemblies; one or more temporary barrier panel configured to couple to the one or more temporary barrier posts; and one or more clips configured to couple the one or more temporary barrier panel to the one or more temporary barrier posts.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is an environmental view of a temporary barrier system according to an embodiment of the present disclosure;

FIG. 2 is a view of a ballast assembly coupled to a temporary barrier panel of the temporary barrier system of FIG. 1, according to an embodiment of the present disclosure;

FIG. 3 is a front perspective view of a ballast assembly according to an embodiment of the present disclosure;

FIG. 4 is a front bottom perspective view of the ballast assembly of FIG. 3;

FIG. 5 is a rear perspective view of the ballast assembly of FIG. 3;

FIG. 6 is a top view of the ballast assembly of FIG. 3;

FIG. 7 is a bottom view of the ballast assembly of FIG. 3;

FIG. 8 is a front view of the ballast assembly of FIG. 3;

FIG. 9 is a front cross-sectional view of the ballast assembly of FIG. 3;

FIG. 10 is a rear view of the ballast assembly of FIG. 3;

FIG. 11 is a first side view of the ballast assembly of FIG. 3;

FIG. 12 is a first side cross-sectional view of the ballast assembly of FIG. 3;

FIG. 13 is a second side view of the ballast assembly of FIG. 3;

FIG. 14 is a perspective view of a clip according to an embodiment of the present disclosure;

FIG. 15 is a perspective view of a clip coupling a temporary barrier post to a temporary barrier panel according to an embodiment of the present disclosure;

FIG. 16 is a photograph of a temporary barrier system according to an embodiment of the present disclosure;

FIG. 17 is a photograph of a temporary barrier system according to an embodiment of the present disclosure;

FIG. 18 is a photograph of a temporary barrier system according to an embodiment of the present disclosure;

FIG. 19 is a photograph of a temporary barrier system according to an embodiment of the present disclosure;

FIG. 20 is a photograph of a temporary barrier system according to an embodiment of the present disclosure;

FIG. 21 is a photograph of a temporary barrier system according to an embodiment of the present disclosure;

FIG. 22 is a photograph of a temporary barrier system according to an embodiment of the present disclosure;

FIG. 23 is a photograph of a temporary barrier system according to an embodiment of the present disclosure; and

FIG. 24 is a photograph of a temporary barrier system according to an embodiment of the present disclosure.

TABLE 1
Drawing elements:

100 temporary barrier system
110 temporary barrier post
120 temporary barrier panel
200 ballast assembly
202 container body
204 ballast receptacle
206 first post-receiving receptacle member
208 post mounting assembly
210 spacers
212 outer portion
214 container lifting assembly
216 ballast
218 side wall
218a first side wall
218b second side wall
218c third side wall
218d fourth side wall
220 floor
222 primary coupling tab
224 primary ground coupling point
226 inner portion
228 base
230 upper rim portion
232 second post-receiving receptacle member
234 receptacle body
234a top open end
234b bottom closed end
236 fastener
238 third post-receiving receptacle member
240 secondary coupling tab
242 secondary ground coupling point
300 clips
301 clip body
302 clip-to-post coupling points
304 clip-to-barrier panel coupling point
306 receiving volume

### DETAILED DESCRIPTION

The detailed description set forth below in connection with the appended drawings, where like numerals reference like elements, is intended as a description of various embodiments of the disclosed subject matter and is not intended to represent the only embodiments. Each embodiment described in this disclosure is provided merely as an example or illustration and should not be construed as preferred or advantageous over other embodiments. The illustrative examples provided herein are not intended to be exhaustive or to limit the claimed subject matter to the precise forms disclosed.

The present disclosure relates generally to an improved rapidly deployable temporary barrier system that provides quick deployment, improved stability against toppling, and can be installed along uneven terrain without requiring timely permitting processes. Further described herein is a temporary ballast assembly configured for integration with a temporary barrier system. Using the systems and methods disclosed herein, secure, adaptable, temporary barrier systems can be installed at a location at a rapid speed. For instance, using the systems and methods disclosed herein, four installers can erect 1000 feet or more of a temporary barrier system per day of work.

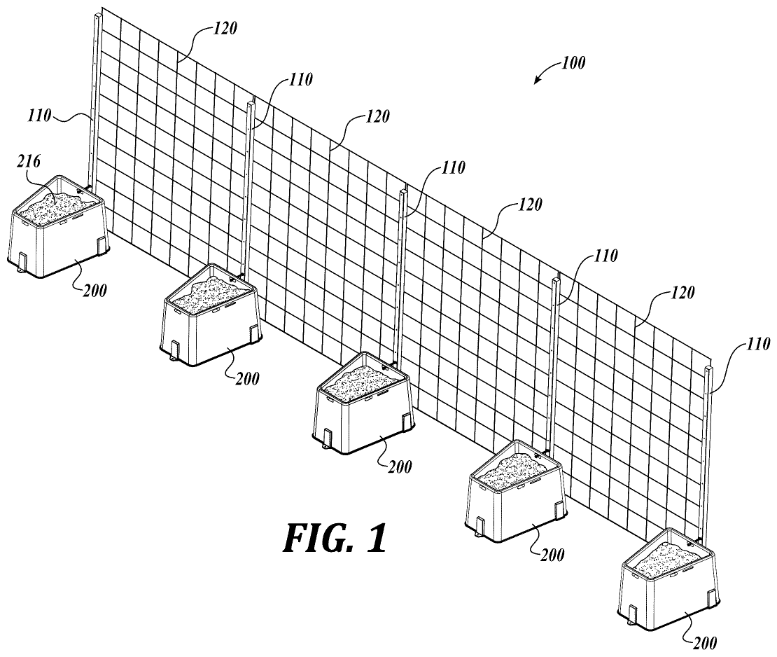

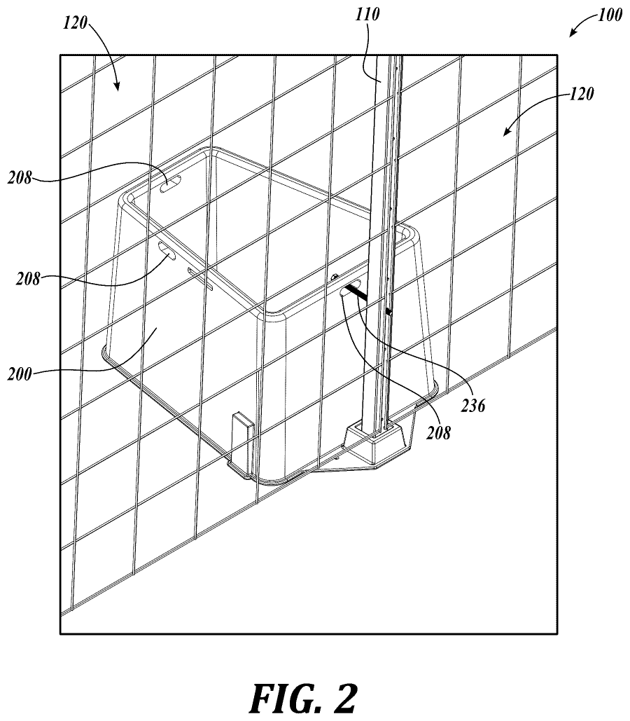

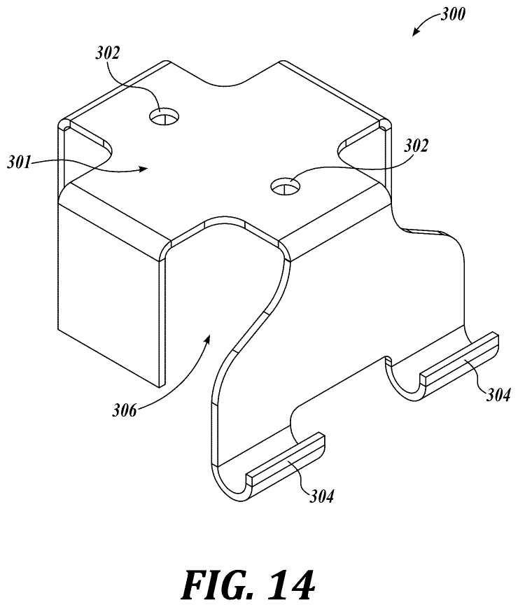

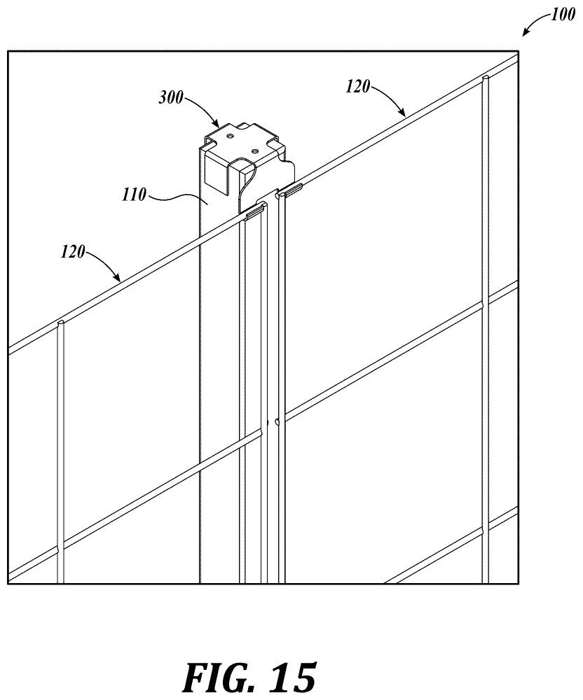

FIG. 1 is an environmental view of a temporary barrier system 100 that may be constructed using a temporary ballast assembly 200, described herein. FIG. 2 is a closeup view of the temporary ballast assembly 200 coupled to the temporary barrier system 100. In the examples described herein, the temporary barrier system 100 includes one or more temporary ballast assemblies 200, one or more temporary barrier posts 110 couplable to the one or more temporary ballast assemblies 200, and one or more temporary barrier panels 120 couplable to the one or more temporary barrier posts 110 (such as using one or more clips 300 described further herein below with respect to FIG. 14 and FIG. 15).

For ease of description, the temporary barrier system 100 will be described with respect to the one or more temporary ballast assemblies 200 with the temporary barrier panels 120 extending substantively along a line and across level ground, such that there is generally a 180-degree angle formed between adjacent temporary barrier panels 120. It should be appreciated, though, that one or more ballast assemblies 200 and/or the temporary barrier panels 120 of the temporary barrier system 100 may be used in any suitable orientation. For instance, adjacent temporary barrier panels 120 may be installed at any angle between about 0 degrees and 180 degrees. In that regard, the temporary barrier system 100 may be configured to substantively enclose an area that is substantively a triangle, a square, a rectangle, a pentagon, a hexagon, an octagon, a nonagon, a decagon, or any other polygon, regular or irregular. Moreover, temporary barrier system 100 may be configured to form a barrier line along substantively level ground, along a slope running perpendicular to the line of the barrier, along a slope running parallel to the line of the barrier, or any combination thereof.

While the temporary barrier system 100 is shown and described with respect to five temporary ballast assemblies 200, four temporary barrier panels 120, and five temporary barrier posts 110, the temporary barrier system 100 can be constructed with any suitable number of component parts to achieve the desired barrier size and structure.

Exemplary aspects of a temporary barrier post 110, which is configured for coupling a temporary ballast assembly 200 to a temporary barrier panel 120, will first be described in detail. The temporary barrier post 110 is generally configured to attach to each of the temporary barrier panels 120 at a plurality of positions to support adaptability of installation, while maintaining structural integrity and preventing intrusions, and while allowing for quick installation for rapid deployment needs.

Temporary barrier post 110 may have any suitable cross-section, such as a substantively round cross section, a substantively rectangular cross section, etc. The length of temporary barrier post 110 may be selected based on the desired temporary barrier system height, while the thickness may be selected, for instance, to optimize for cost efficiency, ease of installation, and structural integrity. In some examples, the temporary barrier post 110 may be formed from any suitable material for coupling a ballast assembly 200 to a temporary barrier panel 120. In some examples, the temporary barrier post 110 may be formed from stainless steel, iron, galvanized iron, aluminum, steel, powder coated steel, polymer coated steel, or polymer.

Coupling of the temporary barrier post 110 to the temporary barrier panel 120 can be accomplished by any suitable means, such as by a plurality of threaded bolts, a plurality of clips, or a plurality of locking bolts. In the depicted example, a plurality of holes extend substantively transversely through the temporary barrier post 110 to receive fasteners therein. The fasteners may pass through the temporary barrier post 110 and the temporary barrier panel 120, as well as to the temporary ballast assembly 200, to enable coupling therebetween. In some examples, the fasteners may pass through the temporary barrier post 110 and a washer clip comprising a plurality of fingers configurable to grab and retain the temporary barrier panel 120.

Exemplary aspects of a temporary barrier panel 120, which is configured for separating areas, will now be described. Generally, the temporary barrier panel 120 may be any suitable configuration applicable for the intended use. In some examples, the temporary barrier panel 120 is designed with an anti-scale material and/or configuration. For instance, the temporary barrier panel 120 may include a chain link, a mesh, or a plurality of crossbars. The temporary barrier panel 120 may instead be defined by any suitable barrier material, such as a polymer material, steel, iron, galvanized iron, a polymer coated metal, aluminum, or a combination thereof.

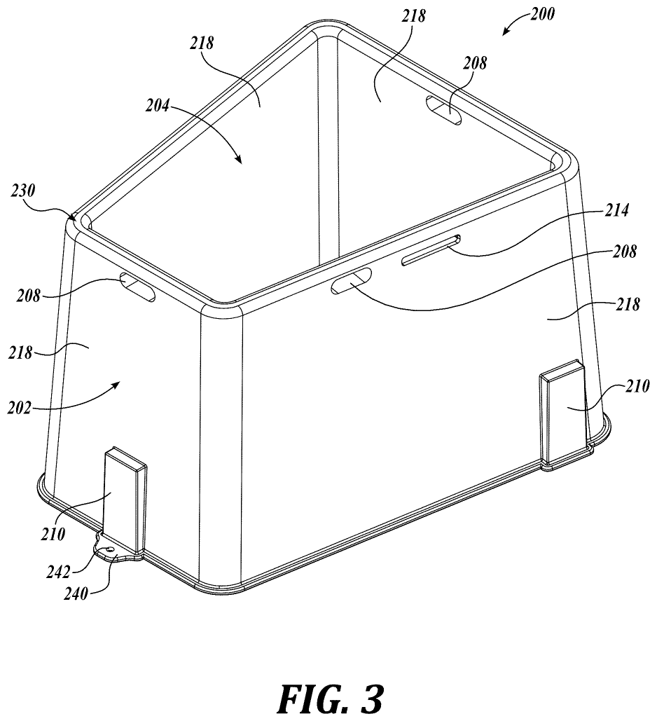

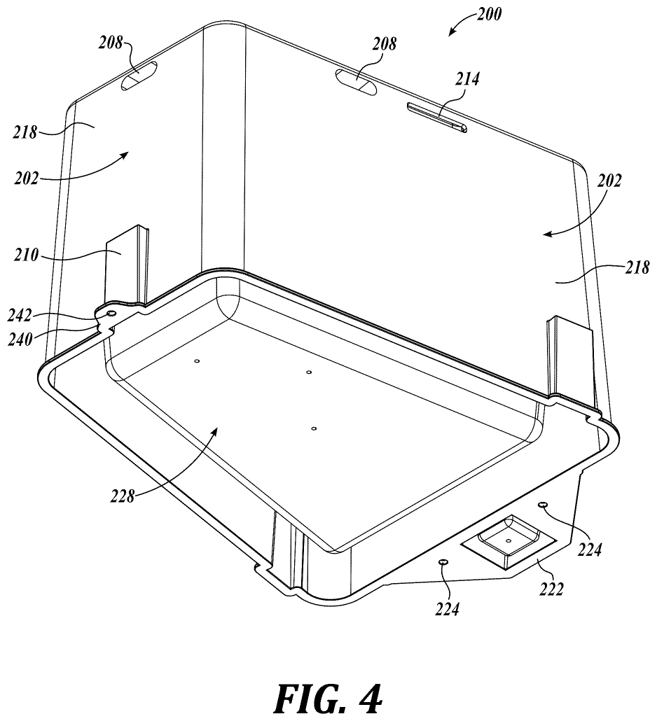

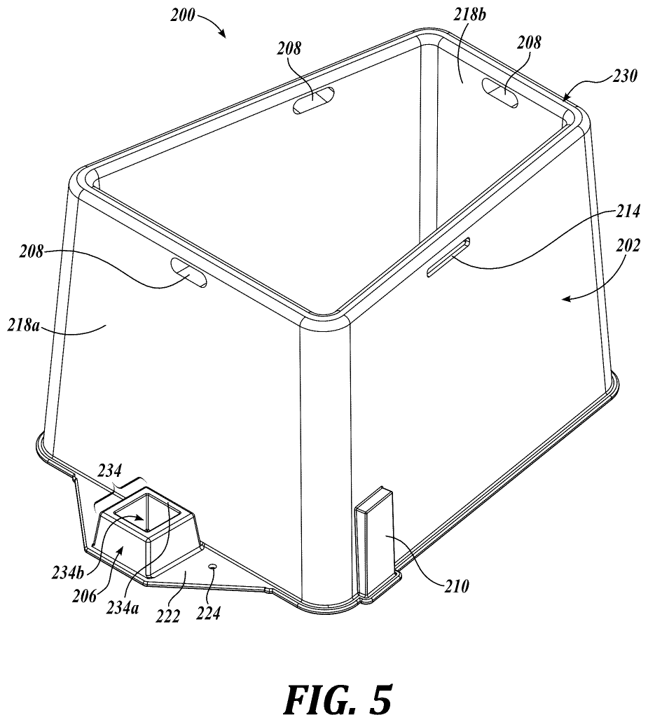

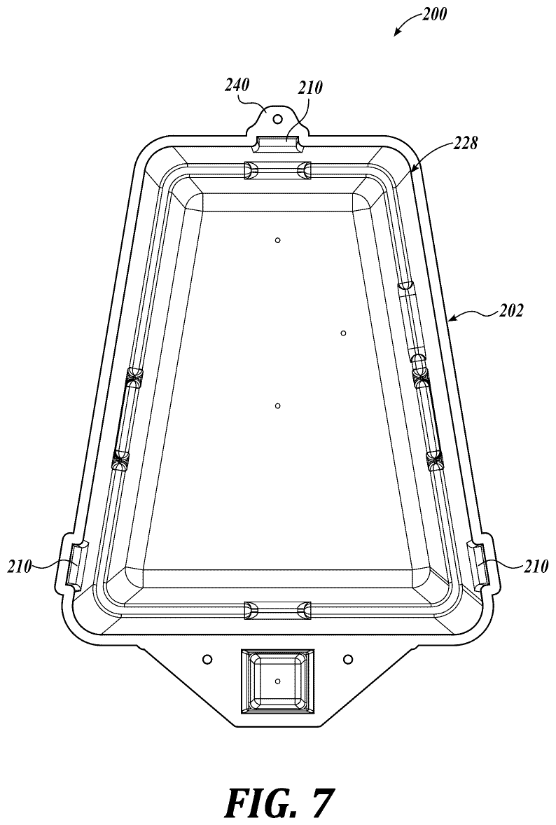

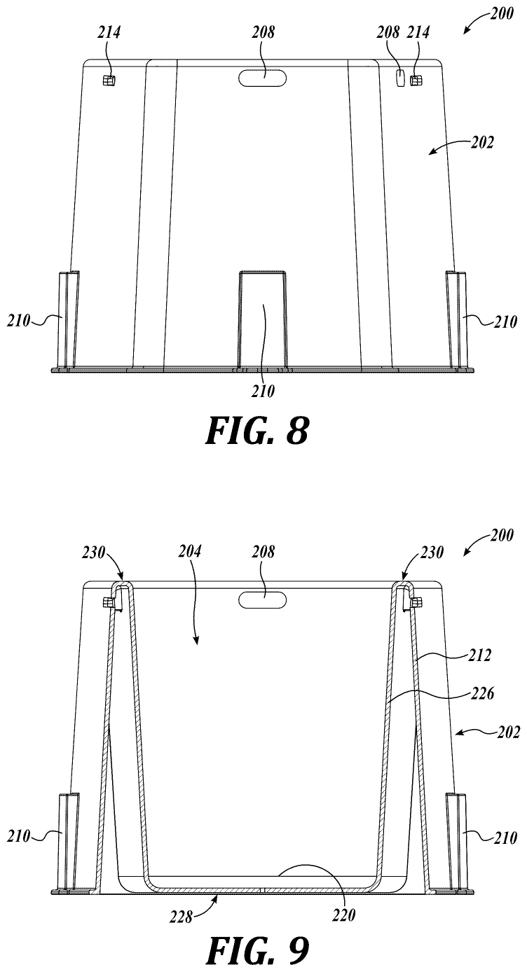

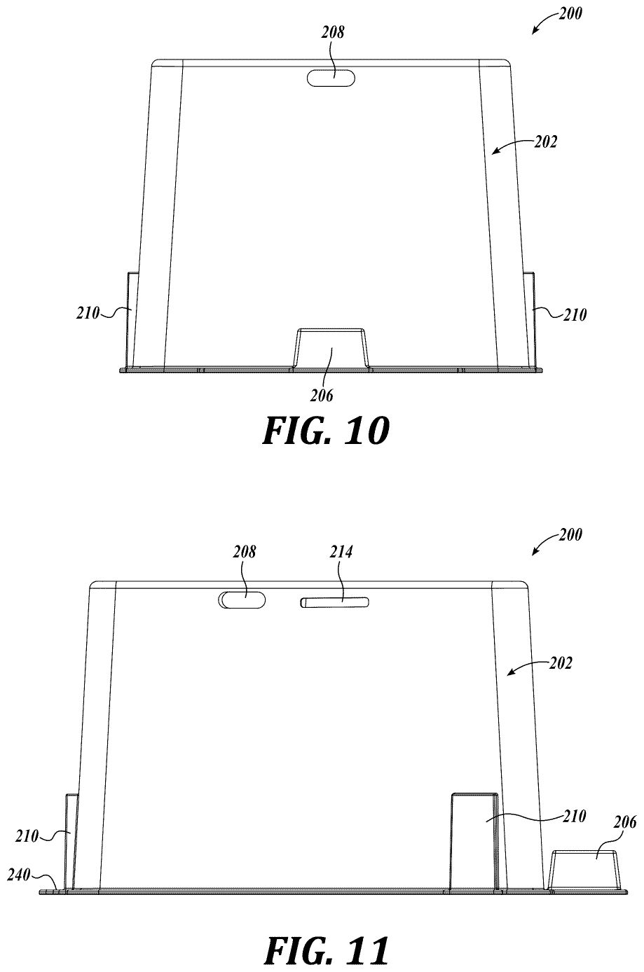

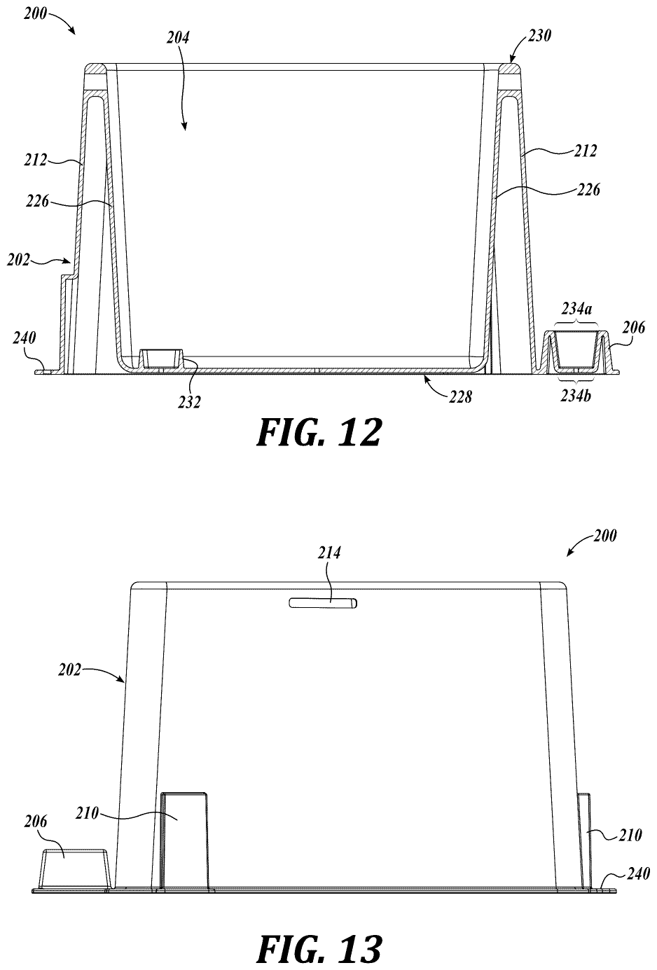

The temporary ballast assembly 200 will next be described with reference to FIGS. 3-13. The temporary ballast assembly 200 is generally configured to enable a heavy substance, such as rocks or gravel, to be temporarily used to provide stability to the temporary barrier post 110 in a flexible, simple, and efficient manner. For instance, an empty temporary ballast assembly 200 can be positioned around the perimeter of a work site or other secure location to define a perimeter for the installation of a temporary barrier system. Minor position and location adjustments may be performed to the lightweight, empty temporary ballast assemblies 200. Once the positions have been defined by the plurality of empty ballast assemblies 200 dispatched throughout the locale, a temporary barrier system can be installed. More specifically, a heavy substance can be added to the temporary ballast assemblies 200 to secure them in place and provide stability to the temporary barrier system.

One major advantage of this configuration is that a worksite can be prepared with relative ease before heavy machinery delivers heavy components. A further advantage is that a heavier ballast load can be used for each segment of the temporary barrier system than would be possible for a traditional barrier system, such as one using metal plates as support ballast for chain link fencing. In traditional systems, ballast weight is limited by the need to enable installers to position the system on site, leading to compromised security. The temporary ballast assemblies 200 described herein can be both installed quickly and efficiently and provide additional security to the barrier system. Yet another advantage is that, when the temporary barrier system is no longer required, the temporary barrier system can be disassembled, and the heavy substance can be easily removed from the temporary ballast assemblies 200. Such temporary ballast assemblies 200 can then be moved for storage or for installation at another location.

In the depicted example, the temporary ballast assembly 200 generally includes a container body 202 defining a ballast receptacle 204 for receiving and retaining ballast, a first post-receiving receptacle member 206 secured to the container body 202 and configured to removably receive a temporary barrier post (such as temporary barrier post 110) in one of a plurality of positions relative to vertical, and a post mounting assembly configured to facilitate coupling of a temporary barrier post (such as temporary barrier post 110) to the container body 202 in each of the plurality of positions relative to vertical.

The container body 202 will first be described in detail. The container body 202 includes a plurality of side walls 218 and a floor 220 that collectively define the ballast receptacle 204. The volume of ballast receptacle 204 is selected so as to receive adequate ballast to provide stability to a corresponding temporary barrier post 110. In some embodiments, the ballast receptacle 204 may contain between about 1 to about 6 cubic feet of material, between about 1 to about 5 cubic feet of material, from about 1 to about 4 cubic feet of material, or from about 2 to about 3 cubic feet of material. Accordingly, when filled with gravel or the like, the ballast receptacle 204 may contain about 200 pounds of ballast, about 300 pounds of ballast, about 400 pounds of ballast, or about 500 pounds of ballast.

The plurality of side walls 218 comprise a first side wall 218a, a second side wall 218b, a third side wall 218c, and a fourth side wall 218d. While a four-sided container body 202 is described for clarity, it is to be understood that additional numbers of side walls are possible and fall within the scope of the present disclosure, such as a container body 202 containing five side walls, six side walls, seven side walls, or more.

Each side wall 218 of the plurality of side walls 218 comprises an inner portion 226 (defining the ballast receptacle 204), an outer portion 212 (defining an exterior of the container body 202), which extend between a base 228 and a upper rim portion 230. The inner portions 226 of each side wall 218 extend generally towards a center of the container body 202, and the outer portions 212 of each side wall 218 extend generally away from a center of the container body 202. Specifically, the interior of the container body 202 generally decreases in cross-sectional size from the upper rim portion 230 of the container body 202 to the base 228 of the container body 202. Such a tapered interior helps facilitate dumping of ballast from the ballast receptacle 204, enabling ballast flow.

At the same time, the outer portion 212 of the container body 202 generally increases in cross-sectional size from the upper rim portion 230 of the container body 202 to the base 228 of the container body 202. The outwardly extending outer portion 212 improves the stability of the ballast assembly 200 by lowering the center of gravity for the ballast assembly 200. The inwardly extending inner portion 226 and outwardly extending outer portion 212 design also supports efficient nesting or stackability of a set of ballast assemblies 200 for convenient storage and transportation. The stackability is efficient, for example, because the corresponding portions of the flared inner portion 226 and outer portion 212 define a receiving gap at the base 228 of the container body 202 that is relatively wide compared to the width of upper rim portion 230 of the container body 202. Accordingly, stacking of one container body 202 on a second container body 202 does not require the careful alignment of walls, such as would be required when stacking a container where the side walls are substantively perpendicular to a base portion of a container. Thus, when a first container body 202 is stacked on a second container body 202, the outer portion 212 of the first container body 202 is proximate the outer portion 212 of the second container body 202, and the inner portion 226 of the first container body 202 is proximate the inner portion 226 of the second container body 202.

Container body 202 may be defined by an injection molded polymer material of a suitable thickness and resistance to strain in order to hold and transport a required volume of ballast, such as gravel. In some embodiments, the container body 202 includes internal reinforcement, such as that provided by reinforcement fibers, a metal mesh material, or any other internal reinforcement features suitable for increasing the durability and strength of injection molded polymer materials. Thus, the material of container body 202 is configured to be resistant to damage from the abrasive action of repeated filling with ballast and dumping of said ballast.

As noted above, in the illustrated embodiment, the ballast assembly 200 is configured to be stackable, such as where the inner portion of a first ballast assembly 200 is nested within an outer portion of a second ballast assembly 200. An advantage of this feature is that many ballast assemblies 200 may be stacked during transport from a warehouse or storage facility to a worksite, thus increasing the number of ballast assemblies 200 that can be delivered for a particular cargo footprint area.

In the depicted example, the ballast assembly 200 includes a plurality of spacers 210 formed on an outer portion 212 of the container body 202. The spacers 210 are configured to substantially prevent container bodies 202 from sticking when stacked. Without being bound by theory, when nested containers are typically stacked, the combined weight can cause compression between subsequent containers in the stack. This can cause containers to become stuck as an inner nested container presses against an outer nested container. By using a plurality of spacers 210, the contact area between an inner and outer nested container is minimized, thus preventing a buildup of friction that results in sticking between containers. In some examples, an angle of a slope of spacers 510 with respect to vertical is less than an angle of a slope of the inner walls of the container body 502 with respect to vertical. In this manner, the spacers 510 may act as a shelf for a top container resting on a bottom container such that the walls between the two containers have a gap when nested.

The ballast assembly 200 may also include a container lifting assembly 214 configured to facilitate both moving and emptying of the ballast assembly 200. In the depicted example, the container lifting assembly 214 is defined by optimally located slots or other openings that are configured to secure first and second lifting straps (not illustrated) to opposite sides of the container body 202. The straps may be secured to a lifting device or moving equipment, such as forks of a forklift. For example, the first and second lifting straps can be coupled to the container body 202 of the ballast assembly 200 by E-Tracks, allowing the ballast assembly 200 to readily interface with commonly used tie-down accessories for ease of transport and dumping.

In some examples, the ballast assembly 200 is further configured so that one of the first and second lifting straps can be selectively released so as to enable dumping of the ballast 216 from the container body 202. Dumping may be accomplished by manipulating the first and second lifting straps such that, when attached, the container body 202 tips to one side, thereby dumping any ballast 216 contained therein. By comparison, a system with built-in forklift receiving slots cannot be used for emptying the ballast assembly 200.

An additional advantage of the container lifting assembly 214 including detachable first and second lifting straps are that they simplify the design of the outer portion 212 of the container body 202. For example, a prior art system with built-in forklift receiving slots will necessarily include additional external features, including ridges or hollow openings, so that there is space to receive forks of a forklift. To allow for lifting of a heavy weight, such forklift receiving slots are typically formed near a bottom edge, and will be formed with sharply defined features so as to allow the container to rest on the ground and still have space to receive forks of a forklift. These external features along a working edge introduce the risk of chipping or breakage due to the presence of the protruding and sharply defined features. By instead including embedded slots for receiving detachable first and second lifting straps, there are fewer exposed edges that can be broken during movement and assembly of the temporary barrier system.

The first post-receiving receptacle member 206 secured to the container body 202 and configured to removably receive a temporary barrier post (such as temporary barrier post 110) in one of a plurality of positions relative to vertical will now be described. In the illustrated example, the first post-receiving receptacle member 206 is located exterior of the container body 202 side walls 218 and is disposed on a primary coupling tab 222 protruding laterally from a side wall 218 of the container body 202. The primary coupling tab 222 may be configured to lie generally flat against a ground surface, with the plane of the primary coupling tab 222 generally co-planar with a bottom flat edge of the base 228 of the container body 202. The first post-receiving receptacle member 206 is defined within the primary coupling tab 222 in a manner that allows for a temporary barrier post, such as temporary barrier post 110, to interface with a side of the ballast assembly 200.

In the illustrated example, the primary coupling tab 222 extends from a side wall 218 of the container body 202. The primary coupling tab 222 may be substantively centered along the base 228 of the first side wall 218a, as shown. The first side wall 218a has a length that is greater than a length of the second side wall 218b, where the first side wall 218a and second side wall 218b are formed on opposite (e.g., front and back) sides of the container body 202. The length of the opposing third side wall 218c and fourth side wall 218d are each greater in length than the first side wall 218a.

Without being bound by theory, this configuration has the advantage of placing the first post-receiving receptacle member 206 adjacent to the widest and thus heaviest portion of the ballast assembly 200. The elongated aspect ratio further allows suitable amounts of ballast to be positioned further from the first post-receiving receptacle member 206, which acts to prevent tipping of the temporary barrier panels due to the application of force farther from the fulcrum point of the temporary barrier system. It also has the advantage of allowing the second side wall 218b of the ballast assembly 200 to be the narrowest portion of the ballast assembly 200, thus increasing the space between adjacent ballast assemblies 200 when installed as part of a temporary barrier system. For example, when installed in a parking lot, adjacent ballast assemblies 200 can be positioned substantively along the parking spot lines, and the narrow footprint of the ballast assembly 200 thus allows cars to continue to park in the parking spots to improve efficiency of space used.

The primary coupling tab 222 may further include one or more primary ground coupling points 224 configured to couple the container body 202 to a first portion of ground via a first ground anchor(s). For instance, the primary coupling tab 222 may include one or more through-holes for receiving a ground anchor(s) therein. In some examples, the first ground anchor is a ground screw, a spike, or a piece of rebar. Thus, when desired, additional support can be provided to a temporary barrier system to maintain the structural integrity of said temporary barrier system, such as to prevent slipping of the ballast assembly 200 across a section of the ground.

In some examples, the first ground anchor is selected so as to not require a permit for installation. In some examples, the first ground anchor is a permanent installation ground anchor, thus allowing for more permanent installation of the temporary barrier system. In some examples, the ballast assembly 200 is removable from the temporary barrier system and a permanent attachment means can be installed in its place. For example, the temporary barrier post 110 may be converted to a permanent installation by de-coupling the ballast assembly 200 from a temporary barrier post 110, decoupling the temporary barrier post 110 from the temporary barrier panel 120, and installing a permanent barrier post anchored in a portion of the ground. The permanent barrier post may then be coupled to the temporary barrier panel 120, thus converting the temporary barrier system 110 into a permanent barrier system.

In some examples, a secondary coupling tab 240 protrudes laterally from the base 228 of the outer portion 212 to provide additional anchoring capabilities. In the example shown, the secondary coupling tab 240 protrudes laterally from the second side wall 218b of the container body 202 and may be generally co-planar with a bottom flat edge of the base 228 of the container body 202. The secondary coupling tab 240 is also substantively centered along the second side wall 218b. The secondary coupling tab 240 includes one or more secondary ground coupling points 242, e.g., holes, configured to couple the secondary coupling tab 240 to a second portion of ground via a second ground anchor. In this manner, additional support can be provided to prevent shifting or slipping of the temporary ballast assembly 200. In some examples, additional coupling tabs can be installed in additional locations around the base 228 of the ballast assembly 200.

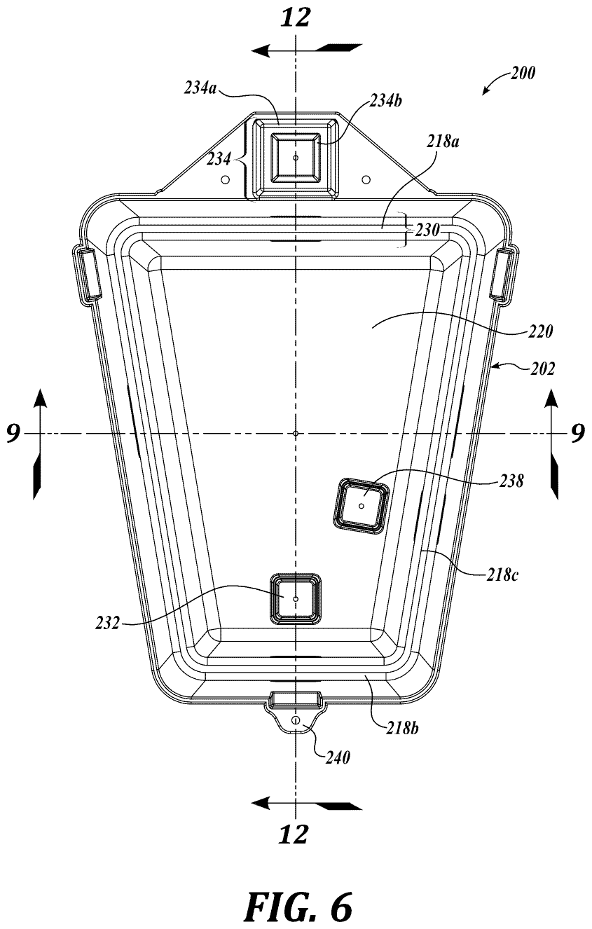

As noted above, the temporary ballast assembly includes a first post-receiving receptacle member 206 secured to the container body 202 and configured to removably receive the temporary barrier post 110 in one of a plurality of positions relative to vertical. The temporary ballast assembly 200 may further include a second post-receiving receptacle member 232 located interior of the container body 202 side walls 218 and on the floor 220 of the container body 202, as is best depicted in FIG. 6. The ballast assembly 200 may also include a third post-receiving receptacle member 238 also located interior of the container body 202 side walls 218 and on the floor 220 of the container body 202. The second post-receiving receptacle member 232 is shown proximate the second side wall 218b, and the third post-receiving receptacle member 238 is shown proximate the third side wall 218c.

The cross-sectional dimensions of the first post-receiving receptacle member 206 may be larger than either of second post-receiving receptacle member 232 or third post-receiving receptacle member 238, the dimensions of first post-receiving receptacle member 206 may be the same as either second post-receiving receptacle member 232 or third post-receiving receptacle member 238, or the dimensions of first post-receiving receptacle member 206 may be the same as both second post-receiving receptacle member 232 and third post-receiving receptacle member 238. Without being bound by theory, the second post-receiving receptacle member 232 and third post-receiving receptacle member 238 may be constructed with smaller cross-sectional dimensions because the temporary barrier post installed therein will be additionally secured by the ballast 216 that will substantially surround the temporary barrier post when installed, thus preventing slippage.

The first post-receiving receptacle member 206, second post-receiving receptacle member 232, and third post-receiving receptacle member 238 may be similar in construction to the container body 202, having sloped interior and exterior side walls. In that regard, each of the post-receiving receptacle members 206, 232, and 238 have a receptacle body 234 that is substantially tapered in cross-sectional size as it extends from a top open end 234a towards a bottom closed end 234b. When any of first post-receiving receptacle member 206, second post-receiving receptacle member 232, or third post-receiving receptacle member 238 receive a temporary barrier post, such as temporary barrier post 110, the interior tapering of the receptacle body 234 allows for the temporary barrier post to be adjusted relative to a vertical axis. In this way, the temporary barrier post can be repositioned so that the positions relative to vertical of the temporary barrier post can be adjusted regardless of ground terrain, thus allowing for installation of a temporary barrier system along or against the slope of a hill while still maintaining a desired vertical orientation of temporary barrier panels.

Without being bound by theory, an advantage of including both a first post-receiving receptacle member 206 on a primary coupling tab 222, and a second post-receiving receptacle member 232 and a third post-receiving receptacle member 238 located interior of the container body 202 side walls 218 is to allow the container body 202 to be positioned in any orientation relative to the temporary barrier post 110 and/or temporary barrier panels 120. For example, container body 202 can be oriented so that the third side wall 218c and fourth side wall 218d run parallel to the temporary barrier panels, thus minimizing the amount to which the ballast assembly 200 protrudes away from the temporary barrier system.

On the other hand, the container body 202 can be oriented so that the second side wall 218b is adjacent to the temporary barrier panels 120, thus placing additional weight away from the fulcrum point of the temporary barrier system and improving the resistance of the temporary barrier system to tipping. Moreover, in some examples, installation of the temporary barrier system 100 using the first post-receiving receptacle member 206 located external the container body 202 can be advantageous when rapid installation is a priority, while installation of the temporary barrier system using the second post-receiving receptacle member 232 or third post-receiving receptacle member 238 can be advantageous when additional structural support against toppling is desired by substantively surrounding each of the temporary barrier posts with ballast.

The post mounting assembly that is configured to facilitate coupling of a temporary barrier post (such as temporary barrier post 110) to the container body 202 in each of a plurality of positions relative to vertical will now be described. In the depicted example, the post mounting assembly is defined by at least one slot 208 configured to adjustably receive a fastener 236. For example, a slot 208 can be defined in the container body 202 proximate the upper rim portion 230 of the container body 202, which may be a thickest portion of the container body 202 to provide a secure attachment point.

The slot 208 of the post mounting assembly may be generally horizontally oriented to enable an installer to adjust the horizontal positioning of a temporary barrier post 110 relative to the container body 202. As can be appreciated, as a temporary barrier post 110 is moved within a post-receiving receptacle member relative to vertical, the attachment location on the container body 202 will change horizontally.

In some examples, the fastener 236 may be a threaded rod securable within the slot 208 via a threaded adjustment nut. The threaded rod may also be couplable to a temporary barrier post 110. After passing through both a temporary barrier post 110 and a slot 208, a threaded adjustment nut may be secured on an end of the fastener 236 so that the nut presses against the inner portion 226 of the side wall 218 proximate the at least one slot. For instance, the threaded adjustment nut may press against the inner portion 226 of the first side wall 218a when the temporary barrier post 110 is engaged with the first post-receiving receptacle member 206. Similarly, the threaded adjustment nut may press against the inner portion 226 of the second side wall 218b when the temporary barrier post 110 is engaged with the second post-receiving receptacle member 232. Moreover, the threaded adjustment nut may press against the inner portion 226 of the third side wall 218c when the temporary barrier post is engaged with the third post-receiving receptacle member 238. By using a threaded rod and threaded adjustment nut, an additional advantage is that an installer can adjust the fore/aft positioning of the temporary barrier post 110 relative to the container body 202, thus enabling the system to maintain ballast for the post at a plurality of positions relative to vertical.

Turning to FIG. 14 and FIG. 15, an exemplary assembly for securing one or more temporary barrier panels 120 to the one or more temporary barrier posts 110 will now be described. In the example shown, a plurality of clips 300 are used to support efficient coupling of the temporary barrier panels 120 to the temporary barrier posts 110. In the illustrated example, the clips 300 each include a generally planar clip body 301 formed to define a generally cubical receiving volume 306. The generally cubical receiving volume 306 is configured to receive an end of a temporary barrier post, such as temporary barrier post 110. At least one side of the generally planar clip body 301 includes one or more clip-to-post coupling points or openings 302, which allow for easy coupling of the clips 300 to the temporary barrier posts, such as with fasteners. In some examples, the clips 600 do not couple to the temporary barrier posts, and instead rest on top of the post and are held in place by friction. In this example, an advantage of a clip 600 held in place by friction is that installation can proceed with significant time savings and require less hardware. Such a design also increases speed and simplifies assembly of the temporary barrier panels 120 to the temporary barrier posts 110.

Each clip 300 further includes one or more clip-to-barrier panel coupling points 304. Each clip-to-barrier panel coupling point 304 is configured to receive or otherwise couple to a portion of a temporary barrier panel 120, such as a horizontal portion of mesh. In that regard, each clip-to-barrier panel coupling point 304 may be defined by an upturned curved lip extending from an edge of the generally planar clip body 301 that is generally sized and shaped to receive a horizontal portion of a temporary barrier panel 120.

As best seen in FIG. 15, during installation, a plurality of temporary barrier posts 110 can be attached to a plurality of ballast assemblies 200 (not shown), as described above. Once the temporary barrier posts 110 and the ballast assemblies 200 are properly positioned at a spacing to receive a temporary barrier panel 120, a clip 300 may be secured to the end of each temporary barrier post 110. Thereafter, temporary barrier panels 120 can be quickly hung from the clip-to-barrier panel coupling point 304 of the clips 300. Further attachment points between the temporary barrier panel 120 and the temporary barrier post 110 can then be installed to securely affix the temporary barrier panel 120 to the temporary barrier post 110. For instance, threaded rods and bolts (not illustrated) may additionally be used to affix the temporary barrier panel 120 to the temporary barrier post 110 at additional points along the length of the temporary barrier post 110. In some examples, the clips 600 can thereafter be removed.

It is to be understood that the means of coupling temporary barrier panels to temporary barrier posts is not limited to the illustrated clips 300, and that other means for rapid installation of temporary barrier panels to installed temporary barrier posts are within the scope of the present disclosure. For instance, a plurality of hooks may be installed along the length of the temporary barrier post 110. The hooks may be securable within slotted engagement points in the temporary barrier panels to directly secure the panels to the temporary barrier posts without secondary attachment means.

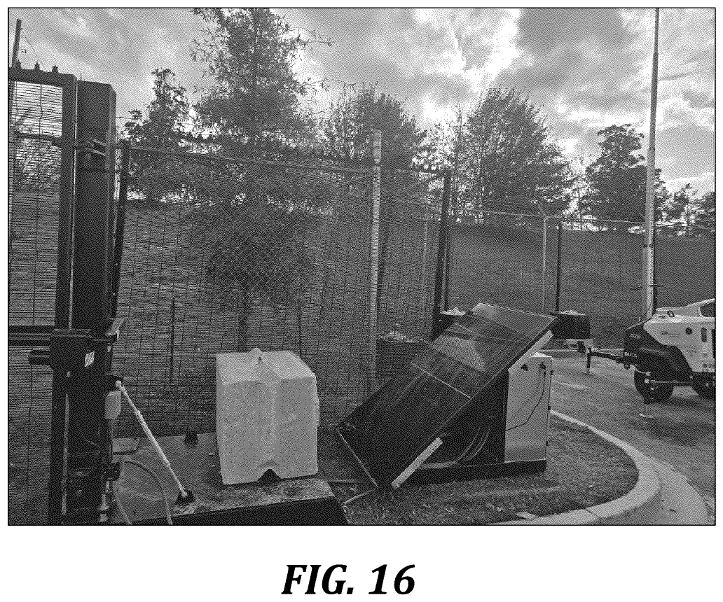

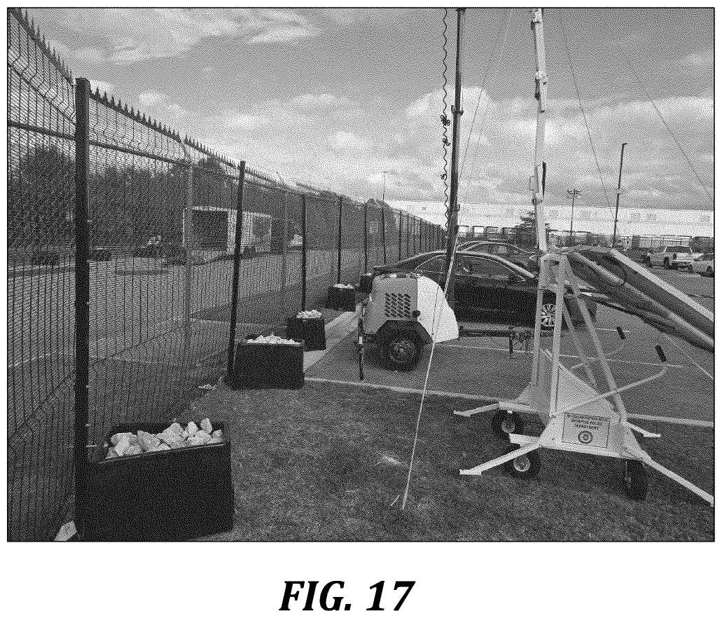

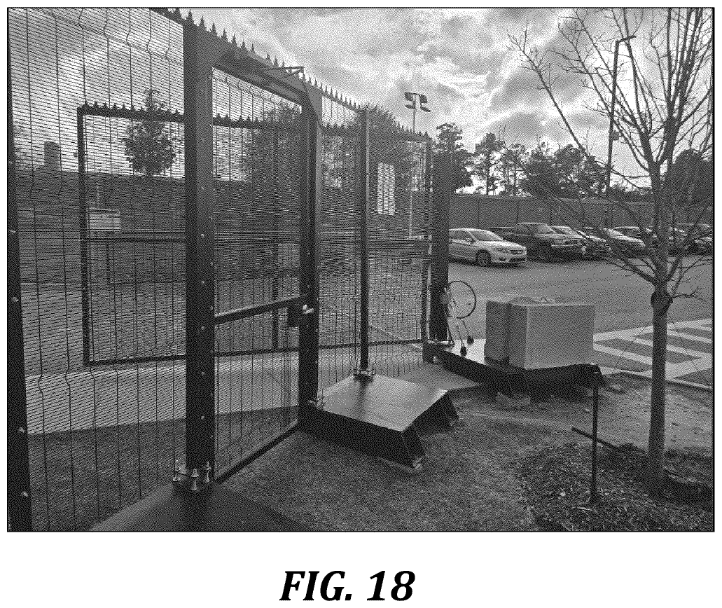

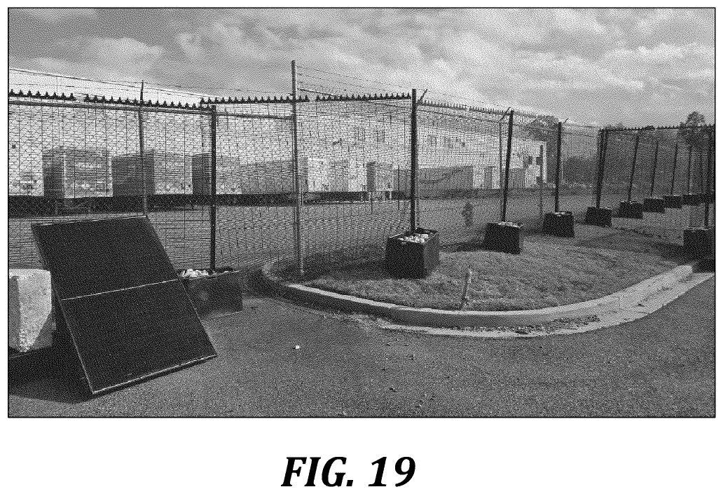

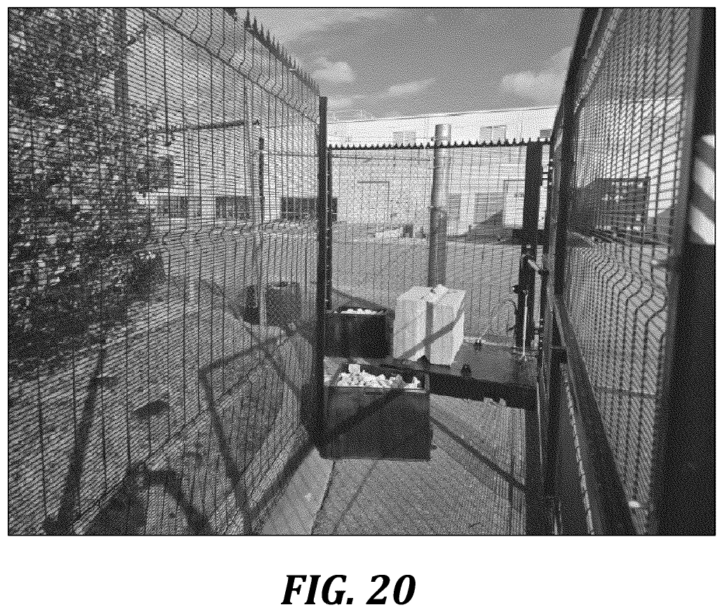

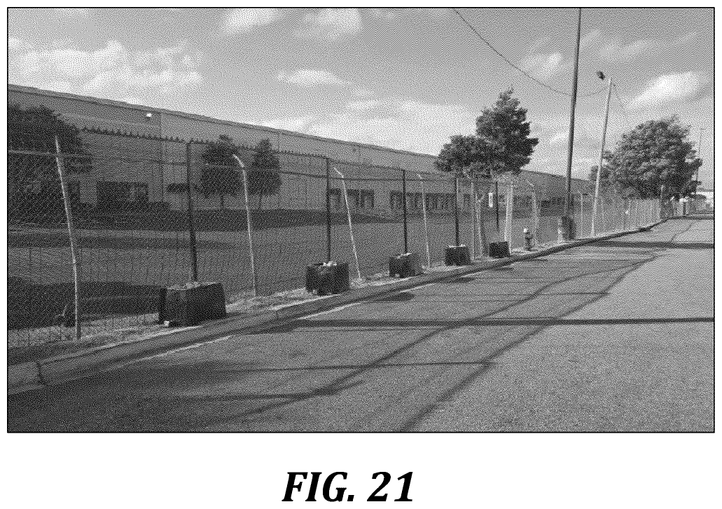

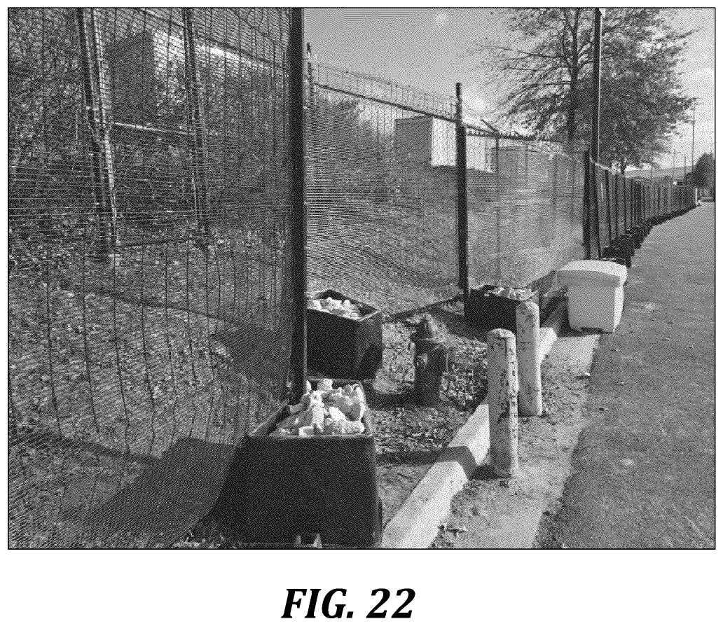

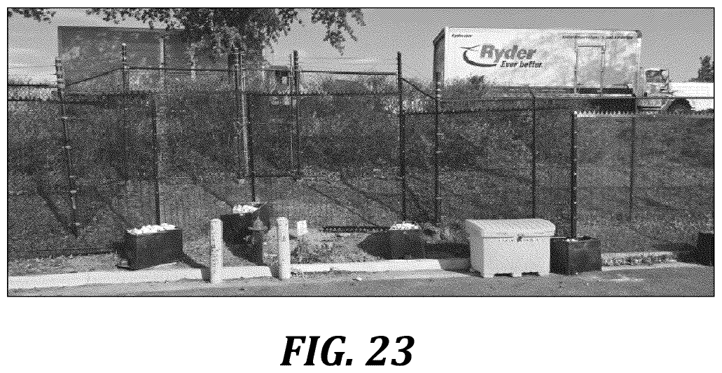

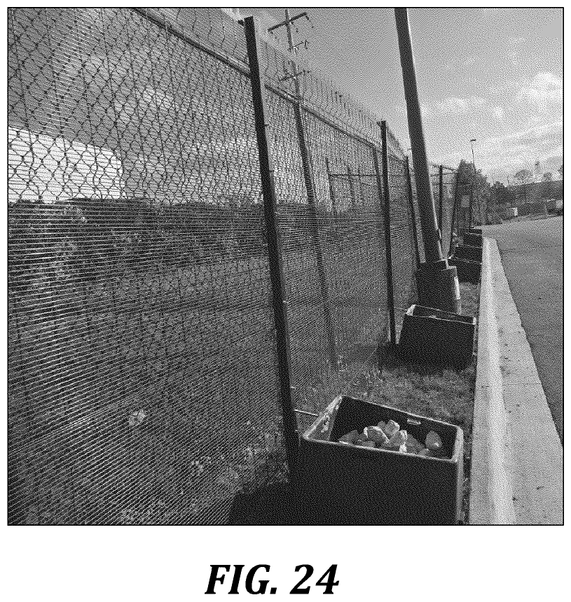

FIG. 16-FIG. 24 provides photographs of temporary barrier systems according to embodiments of the present disclosure.

The detailed description set forth above in connection with the appended drawings, where like numerals reference like elements, are intended as a description of various examples of the present disclosure and are not intended to represent the only examples. Each example described in this disclosure is provided as a representative example or illustration and should not be construed as preferred or advantageous over other examples. The representative examples provided herein are not intended to be exhaustive or to limit the disclosure to the precise forms disclosed. Similarly, any steps described herein may be interchangeable with other steps, or combinations of steps, in order to achieve the same or substantially similar result. Generally, the examples disclosed herein are non-limiting, and the inventors contemplate that other examples within the scope of this disclosure may include structures and functionalities from more than one specific example shown in the figures and described in the specification. That is, the present disclosure includes examples that combine features from different examples.

In the foregoing description, specific details are set forth to provide a thorough understanding of exemplary examples of the present disclosure. It will be apparent to one skilled in the art, however, that the examples disclosed herein may be practiced without embodying all the specific details. In some instances, well-known process steps have not been described in detail in order not to unnecessarily obscure various aspects of the present disclosure. Further, it will be appreciated that examples of the present disclosure may employ any combination of features described herein.

In the detailed description herein, references to “one example”, “an example”, “one or more examples, etc., indicate that the example described may include a particular feature, structure, or characteristic, but every example may not necessarily include the particular feature, structure, or characteristic. Moreover, such phrases are not necessarily referring to the same example. In addition, when a particular feature, structure, or characteristic is described in connection with an example, it is submitted that it is within the knowledge of one skilled in the art to affect such feature, structure, or characteristic in connection with other examples whether or not explicitly described. After reading the description, it will be apparent to one skilled in the relevant art(s) how to implement the disclosure in alternative examples. Thus, it will be appreciated that examples of the present disclosure may employ any combination of features described herein. All such combinations or sub-combinations of features are within the scope of the present disclosure.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this disclosure, the same or similar elements may bear the same references. Furthermore, the presence of reference numbers or letters in the drawings cannot be considered limiting, even when such numbers or letters are indicated in the claims.

In the claims and for purposes of the present disclosure, the terms “a”, “an”, “the”, and the like, refer to the singular and the plural forms of the object or element referenced.

The present application may include references to directions, such as “vertical,” “horizontal,” “front,” “rear,” “left,” “right,” “top,” and “bottom,” etc. These references, and other similar references in the present application, are intended to assist in helping describe and understand the particular example (such as when the example is positioned for use) and are not intended to limit the present disclosure to these directions or locations.

The present application may also reference quantities and numbers. Unless specifically stated, such quantities and numbers are not to be considered restrictive, but exemplary of the possible quantities or numbers associated with the present application. Also in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value. The term “based upon” means “based at least partially upon.”

The principles, representative examples, and modes of operation of the present disclosure have been described in the foregoing description. However, aspects of the present disclosure, which are intended to be protected, are not to be construed as limited to the particular examples disclosed. Further, the examples described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. A ballast assembly for a temporary barrier system, comprising:
a container body defining a ballast receptacle for receiving and retaining ballast;
a first post-receiving receptacle member secured to the container body and configured to removably receive a temporary barrier post in one of a plurality of positions relative to vertical; and
a post mounting assembly configured to facilitate coupling of the temporary barrier post to the container body in each of the plurality of positions relative to vertical.

2. The ballast assembly of claim 1, wherein the ballast assembly is configured to be stackable.

3. The ballast assembly of claim 2, further comprising a plurality of spacers disposed on an outer portion of the container body configured to substantially prevent container bodies from sticking when stacked.

4. The ballast assembly of claim 1, further comprising a container lifting assembly configured to secure first and second lifting straps to opposite sides of the container body and selectively be released from one of the first and second lifting straps to enable dumping of ballast from the container body.

5. The ballast assembly of claim 4, wherein the first and second lifting straps, when attached, are configured so that the container body can be tipped to one side, thereby dumping any ballast contained therein.

6. The ballast assembly of claim 1, wherein the container body comprises a plurality of side walls and a floor collectively defining the ballast receptacle, and wherein the first post-receiving receptacle member is located exterior of the container body side walls on a primary coupling tab protruding from the container body.

7. The ballast assembly of claim 6, wherein the primary coupling tab comprises one or more primary ground coupling points configured to couple to a first portion of ground via a first ground anchor.

8. The ballast assembly of claim 7, wherein the first ground anchor is a ground screw.

9. The ballast assembly of claim 6, wherein the plurality of side walls comprises a first side wall, a second side wall, a third side wall, and a fourth side wall, each side wall of the plurality of side walls comprising an inner portion, an outer portion, a base, and a lip.

10. The ballast assembly of claim 9, wherein the primary coupling tab is substantively centered along the base of the first side wall.

11. The ballast assembly of claim 9, wherein a length of the first side wall is greater than a length of the second side wall.

12. The ballast assembly of claim 9, wherein a length of the third side wall and a length of the fourth side wall are each greater than a length of the first side wall.

13. The ballast assembly of claim 9, further comprising a second post-receiving receptacle member located interior of the container body side walls on the floor of the container body.

14. The ballast assembly of claim 13, wherein the first post-receiving receptacle member and the second post-receiving receptacle member each have a receptacle body that is substantially tapered in width as it extends from a top open end toward a bottom closed end.

15. The ballast assembly of claim 14, wherein the first post-receiving receptacle member and second post-receiving receptacle member are configured to so that the positions relative to vertical of the temporary barrier post can be adjusted around a pivot point.

16. The ballast assembly of claim 13, wherein the post mounting assembly is defined by at least one slot configured to adjustably receive a fastener.

17. The ballast assembly of claim 16, wherein the fastener comprises a threaded rod and a threaded adjustment nut, wherein the threaded rod is configured to couple to the temporary barrier post, and wherein the threaded adjustment nut is configured to press against the inner portion of the first side wall proximate the at least one slot.

18. The ballast assembly of claim 13, wherein the second post-receiving receptacle member is proximate the second side wall.

19. (canceled)

20. The ballast assembly of claim 9, further comprising a secondary coupling tab protruding from the base of the outer portion of the second side wall of the plurality of side walls, said secondary coupling tab comprising one or more secondary ground coupling points being configured to couple to a second portion of ground via a second ground anchor.

21. (canceled)

22. A temporary barrier system comprising:
one or more of the ballast assemblies of claim 1;
one or more temporary barrier posts configured to couple to the one or more ballast assemblies;
one or more temporary barrier panel configured to couple to the one or more temporary barrier posts; and
one or more clips configured to couple the one or more temporary barrier panel to the one or more temporary barrier posts.
